(19) United States
(12) Patent Application Publication
(10) Pub. No.: US 2006/0063014 A1
(43) Pub. Date: Mar. 23, 2006

(54) Polyalkylsilsesquioxane-filled adhesive compositions and methods for use thereof

(76) Inventor: Debbie Forray, San Diego, CA (US)

Correspondence Address: Kevin Forrestal;Advanced Applied Adhesives, 10080 Willow Creek Rd, San Diego, CA, 92131, US

(21) Appl. No.: 11/179,415

(22) Filed: Jul. 12, 2005

Related U.S. Application Data
(60) Provisional application No. 60/587,330, filed on Jul. 12, 2004.

(51) Int. Cl. B32B 7/12; C08L 83/04; C09J 183/04; B05D 3/02

(52) U.S. Cl. 428/448; 525/474; 156/329

(57) ABSTRACT

The invention is based on the discovery that polyalkylsilsesquioxanes can be used as fillers for the preparation of adhesive formulations having excellent dielectric properties, i.e., very low conductivities. Invention compositions display excellent rheological properties, in addition to low dielectric constants.

### RELATED APPLICATIONS

This application claims the benefit of priority of U.S. Provisional Application Ser. No. 60/587,330 filed Jul. 12, 2004, the entire disclosure of which is incorporated herein by reference.

### FIELD OF THE INVENTION

The present invention relates to thermosetting adhesive compositions, methods of preparation and uses therefor. In particular, the present invention relates to thermosetting compositions having excellent dielectric properties, i.e., very low conductivities. In another aspect, the present invention relates to polyalkylsilsesquioxane-filled adhesive formulations.

### BACKGROUND OF THE INVENTION

As the electronics industry advances, and production of light weight components increases, the development of new materials gives producers increased options for further improving the performance and ease of manufacture of such components. Adhesive compositions, particularly conductive adhesives, are used for a variety of purposes in the fabrication and assembly of semiconductor packages and microelectronic devices. The more prominent uses include bonding of electronic elements such as integrated circuit chips to lead frames or other substrates, and bonding of circuit packages or assemblies to printed wire boards.

Adhesives used in the electronic packaging industry typically contain a thermosetting resin combined with a filler and some type of curing initiator. These resins are primarily used in the electronics industry for the preparation of non-hermetic electronic packages. Adhesives useful for electronic packaging applications typically exhibit properties such as good mechanical strength, curing properties that do not affect the component or the carrier, and thixotropic properties compatible with application to microelectronic and semiconductor components. Examples of such packages are ball grid array (BGA) assemblies, super ball grid arrays, IC memory cards, chip carriers, hybrid circuits, chip-on-board, multi-chip modules, pin grid arrays, and the like.

In addition, there are many potential applications for adhesives having electrically insulating properties. Such materials must, however, satisfy a combination of criteria, i.e., in addition to exhibiting a low dielectric constant, such materials must also have good dispensability and good adhesion properties. Non-conductive fillers traditionally employed for the preparation of adhesives having electrically insulating properties include aluminum nitride, boron nitride, alumina, silicon dioxide, and the like.

The rheology of an adhesive paste is a very important consideration for manufacturing purposes. For example, separation of the filler from the resin in the syringe, a clean break of adhesive between each dispense thereof, and the presence of drip-free syringes in the dispense operation are all important attributes for consistent dispensing properties.

For all these applications, the microelectronics industry continues to require new resins that are able to meet its varying demands. Accordingly, there is a need for the development of compositions and formulations to address the requirements of this rapidly evolving industry.

### SUMMARY OF THE INVENTION

The invention is based on the discovery that polyalkylsilsesquioxanes can be used as fillers for the preparation of adhesive formulations having excellent dielectric properties, i.e., very low conductivities. Invention compositions display excellent Theological properties, in addition to low dielectric constants.

Invention formulations possess a low dielectric constant (Dₖ). The dielectric constant is a dimensionless ratio which provides a measure of the degree to which a material can resist the flow of electric charge independent of the field strength. Furthermore, the polyalkylsilsesquioxane fillers employed for the preparation of invention formulations impart a low dissipation factor (D_{f}) to the resulting formulations. Low D_{f} materials are noted for their resistance to leakage of electrical current under an applied charge. Invention formulations can be used for a variety of purposes, such as, for example, for the preparation of filled adhesive formulations with a reduced propensity to settle out, excellent dispensing characteristics due to the thixotropic nature thereof, and the like.

In one embodiment of the invention, there are provided adhesive compositions including a polymerizable monomer vehicle selected from maleimides, (meth)acrylates, vinyl ethers, vinyl esters, urethanes, polyesters, polyester-linked (meth)acrylates, styrenic compounds or allyl functional compounds, or a mixture of any two or more therefore, a polyalkylsilsesquioxane, and a curing catalyst.

In another embodiment, there are provided assemblies including a first article permanently adhered to a second article by a cured aliquot of a composition including a polymerizable monomer vehicle, a polyalkylsilsesquioxane, and a curing catalyst.

In another embodiment, there are provided assemblies including a microelectronic device permanently adhered to a substrate by a cured aliquot of a composition including a polymerizable monomer vehicle, a polyalkylsilsesquioxane, and a curing catalyst.

In still another embodiment, there are provided methods for adhesively attaching a first article to a second article. Such methods can be performed, for example, by (a) applying an adhesive composition to the first article, wherein the adhesive composition includes a polymerizable monomer vehicle, a polyalkylsilsesquioxane, and a curing catalyst, (b) bringing the first and second article into intimate contact to form an assembly wherein the first article and the second article are separated only by the adhesive composition applied in step (a), and thereafter, (c) subjecting the assembly to conditions suitable to cure the adhesive composition.

In another embodiment, there are provided methods for adhesively attaching a microelectronic device to a substrate. Such methods can be performed, for example, by (a) applying an adhesive composition to the substrate and/or the microelectronic device, wherein the adhesive composition comprises a polymerizable monomer vehicle, a polyalkylsilsesquioxane, and a curing catalyst, (b) bringing the substrate and the device into intimate contact to form an assembly wherein the substrate and the device are separated only by the composition applied in step (a), and thereafter, (c) subjecting the assembly to conditions suitable to cure the composition.

### DETAILED DESCRIPTION OF THE INVENTION

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described. Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

The invention is based on the discovery that polyalkylsilsesquioxanes can be used as fillers for the preparation of adhesive formulations having excellent dielectric properties, i.e., very low conductivities. Invention compositions display excellent rheological properties, in addition to low dielectric constants.

As used herein, “aliphatic” refers to any alkyl, alkenyl, or cycloalkyl moiety.

As used herein, “alkyl” refers to straight or branched chain hydrocarbyl groups having from 1 up to about 100 carbon atoms. “Substituted alkyl” refers to alkyl moieties bearing substituents including alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —C(O)—, —S—, —S(O)₂, —OC(O)—O—, —NR—C(O), —NR—C(O)—NR, —OC(O)—NR, wherein R is H or lower alkyl, acyl, oxyacyl, carboxyl, carbamate, sulfonyl, sulfonamide, sulfuryl, and the like.

As used herein, “cycloalkyl” refers to cyclic ring-containing groups containing in the range of about 5 up to about 20 carbon atoms, and “substituted cycloalkyl” refers to cycloalkyl groups further bearing one or more substituents as set forth above. In some embodiments, the cycloalkyl refers to cyclic ring-containing groups containing in the range of about 5 up to about 12 carbon atoms

As used herein, “aryl” refers to aromatic groups having in the range of 6 up to 14 carbon atoms and “substituted aryl” refers to aryl groups further bearing one or more substituents as set forth above.

In one embodiment of the invention, there are provided adhesive compositions including a polymerizable monomer vehicle selected from maleimides, (meth)acrylates, vinyl ethers, vinyl esters, urethanes, polyesters, polyester-linked (meth)acrylates, styrenic compounds or allyl functional compounds, or a mixture of any two or more therefore, a polyalkylsilsesquioxane, and a curing catalyst.

As readily recognized by those of skill in the art, a wide variety of additional components can optionally be incorporated into the above-described compositoins, such as, for example, coupling agents, anti-oxidants, stabilizers, bleed control agents, additional fillers (other than the required polyalkylsilsesquioxane filler), inert diluents, reactive diluents, adhesion promoters, flexibilizers, dyes, pigments, and the like.

While the use of inert diluents is not excluded from the practice of the invention, it is generally preferred that compositions of the invention remain substantially free of solvent, so as to avoid the potentially detrimental effects thereof, e.g., creation of voids caused by solvent escape, the environmental impact of vaporized solvent, the redeposition of outgassed molecules in the surface of the article, and the like.

Monomer vehicles contemplated for use in accordance with the present invention include maleimides, (meth)acrylates, vinyl ethers, vinyl esters, urethanes, polyesters, polyester-linked (meth)acrylates, styrenic compounds or allyl functional compounds, or a mixture of any two or more therefore.

Exemplary maleimides contemplated for use in the practice of the invention include compounds having the structure: 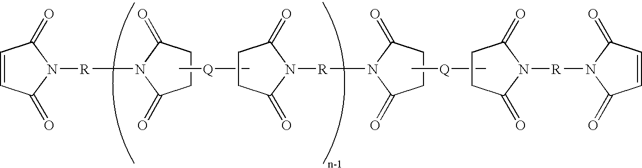
wherein:
   R and Q are each independently substituted or unsubstituted aliphatic, aromatic, heteroaromatic, or siloxane moieties; and
   n is 1 to about 10.

In some embodiments, R and Q are each independently substituted or unsubstituted linear, branched, or cyclic aliphatic moieties having from 2 to about 100 carbon atoms. In other embodiments, R and Q are each independently substituted or unsubstituted aromatic or heteroaromatic moieties having from 6 to about 14 carbon atoms. In still other embodiments, n is 1-6. In still further embodiments, n is 1-4. In one embodiment, n is 2.

Exemplary urethanes contemplated for use in the practice of the invention include compounds having the structure: 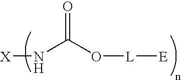
wherein:
   X is a substituted or unsubstituted aliphatic, aryl or heterocyclic;
   each E is independently a polymerizable moiety selected from acrylate, methacrylate, olefin, epoxy, maleimide, vinyl ether, or vinyl ester;
   each L is independently a bond or an alkylene or oxyalkylene linker; and
   n is 1 to about 10.

In some embodiments, X is a substituted or unsubstituted linear, branched, or cyclic aliphatic moiety having from 2 to about 100 carbon atoms. In other embodiments, X is a substituted or unsubstituted aryl or heterocyclic moiety having from 6 to about 14 carbon atoms. In other embodiments, X is a substituted or unsubstituted linear, branched, or cyclic aliphatic moiety having from 2 to about 50 carbon atoms. In still further embodiments, n is 1 to about 5. In further embodiments, n is 1 to about 3. In one embodiment, n is 2.

Exemplary polyester-linked methacrylates contemplated for use in the practice of the invention include compounds having the structure: 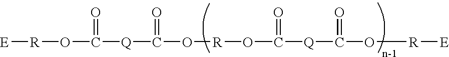
wherein:
   R and Q are each independently substituted or unsubstituted aliphatic, aryl, or heteroaryl;
   each E is independently an acrylate or a methacrylate; and
   n is 1 to about 10.

In some embodiments, R is a substituted or unsubstituted cycloalkyl having from 5 to about 20 carbon atoms. In other embodiments, R is a substituted or unsubstituted cycloalkyl having from 5 to about 12 carbon atoms. In still other embodiments, R is a substituted or unsubstituted cyclopentyl, cyclohexyl, norbornyl, tetracyclododecyl, or dicyclopentadienyl.

In some embodiments, Q is a substituted or unsubstituted aryl or heteroaryl having from 6 to about 14 carbon atoms. In certain embodiments, Q is a substituted or unsubstituted phenyl or naphthyl. In other embodiments, Q is a substituted or unsubstituted cycloalkyl. In one embodiment, Q is a substituted or unsubstituted norbornenyl.

A wide variety of polyalkylsilsesquioxane fillers are contemplated for use in the practice of the invention. In some embodiments, the polyalkylsilsesquioxane is a polymethylsilsesquioxane, polyethylsilsesquioxane, polypropylsilsesquioxane, polybutylsilsesquioxane, polypentylylsilsesquioxane, polyhexylsilsesquioxane, polycyclohexylsilsesquioxane, and the like. In certain embodiments, the polyalkylsilsesquioxane is a polymethylsilsesquioxane, polyethylsilsesquioxane, or polypropylsilsesquioxane. In one embodiment, the polyalkylsilsesquioxane is polymethylsilsesquioxane. Many such materials are available commercially, for example, from GE Silicones under the tradename “Tospearl”. Exemplary polyalkylsilsesquioxane fillers contemplated for use in the practice of the invention are typically characterized as having a particle size in the range of about 1.0 μm up to about 10 μm, and a surface area in the range of about 10 m²/g to about 50 m²/g. In certain embodiments, the particle size is in the range of about 1.0 μm up to about 6 μm, and the surface area in the range of about 20 m²/g to about 30 m²/g.

As readily recognized by those of skill in the art, a wide variety of curing catalysts can be employed in the preparation of invention compositions. The preferred catalyst to be used will, of course, depend on the monomer vehicle employed. For example, for those monomer vehicles which cure by a free radical mechanism, free radical initiators such as peroxy esters, peroxy carbonates, hydroperoxides, alkylperoxides, arylperoxides, and the like can be employed.

For those monomer vehicles which cure by cationic and/or anionic polymerization, cationic catalysts, transition metal catalysts, and the like can be employed. Exemplary cationic catalysts contemplated for use herein include onium salts, iodonium salts, sulfonium salts, and the like.

Exemplary transition metal catalysts contemplated for use herein include nickel, copper, cobalt and the like, in the form of a chelate, a soap, or the like.

The ratio of the various components of invention compositions can vary within wide ranges. For example, the quantity of monomer vehicle can vary anywhere within the range of about 25 to about 90 weight percent (wt %) of invention composition. In some embodiments, the quantity of monomer vehicle is in the range of about 40 up to about 80 wt % (based on the total weight of the final composition).

Similarly, the quantity of polyalkylsilsesquioxane employed in the practice of the invention can vary within wide ranges, typically falling in the range of about 10 up to about 75 wt % of invention composition. In some embodiments, the polyalkylsilsesquioxane is present in the composition in the range of about 20 up to about 60 wt % (based on the total weight of the final composition).

The quantity of curing catalyst employed in the practice of the invention can also vary widely, typically falling in the range of about 0.01 up to about 10 wt % of the composition (based on the total weight of the finished composition). As readily recognized by those of skill in the art, quantities at the lower end of this range are generally suitable when using transition metal catalysts, while quantities falling in the middle to the upper end of the range are generally suitable when free radical initiators are employed.

Invention compositions have excellent handling properties, typically existing as a thixotropic paste, which can readily be dispensed using standard equipment.

In another embodiment of the invention, there are provided methods for adhesively attaching a first article to a second article. Such methods can be performed, for example, by (a) applying an adhesive composition to the first article, wherein the adhesive composition includes a polymerizable monomer vehicle, a polyalkylsilsesquioxane, and a curing catalyst, (b) bringing the first and second article into intimate contact to form an assembly wherein the first article and the second article are separated only by the adhesive composition applied in step (a), and thereafter, (c) subjecting the assembly to conditions suitable to cure the adhesive composition.

Curing conditions contemplated for carrying out the above-described method typically comprise a temperature in the range of about 100° C. up to 250° C., for in the range of about 0.001 up to about 6 hours. In some embodiments, the range is 0.01 up to about 0.5 hours.

In another embodiment of the invention, there are provided methods for adhesively attaching a microelectronic device to a substrate. Such methods can be performed, for example, by (a) applying an adhesive composition to the substrate and/or the microelectronic device, wherein the adhesive composition includes a polymerizable monomer vehicle, a polyalkylsilsesquioxane, and a curing catalyst, (b) bringing the substrate and the device into intimate contact to form an assembly wherein the substrate and the device are separated only by the composition applied in step (a), and thereafter, (c) subjecting the assembly to conditions suitable to cure the composition.

Curing conditions contemplated for carrying out the above-described method typically comprise a temperature in the range of about 100° C. up to 250° C., for in the range of about 0.001 up to about 6 hours. In some embodiments, the range is 0.01 up to about 0.5 hours.

In another embodiment of the invention, there are provided assemblies including a first article permanently adhered to a second article by a cured aliquot of the above-described composition. Such assemblies can be prepared from a variety of structures, e.g., wherein the first article is selected from a silicon-based microelectronic device, a gallium arsenide-based microelectronic device, a quartz-based microelectronic device, a sapphire-based microelectronic device, an indium phosphide-based microelectronic device, a cadmium sulfide-based microelectronic device, lithium niobate-based microelectronic device, and the like, and the second article is selected from lead frames, pin grid arrays, ceramics, and the like.

In a further embodiment of the invention, there are provided assemblies including a microelectronic device permanently adhered to a substrate by a cured aliquot of the above-described composition. Microelectronic devices contemplated for use in the practice of the present invention include lead frames, pin grid arrays, laminate materials, and the like.

As readily recognized by those of skill in the art, compositions according to the present invention can also be employed for the preparation of a variety of structures, e.g., advanced composites, molding resins, glob-top structures, underfill materials, and the like, employing techniques which are readily available in the art.

While the invention has been described in detail with reference to certain preferred embodiments thereof, it will be understood that modifications and variations are within the spirit and scope of that which is described and claimed.

What is claimed is:

1. An adhesive composition comprising:
a polymerizable monomer vehicle selected from maleimides, (meth)acrylates, vinyl ethers, vinyl esters, urethanes, polyesters, polyester-linked (meth)acrylates, styrenic compounds or allyl functional compounds, or a mixture of any two or more therefore, a polyalkylsilsesquioxane, and a curing catalyst.

2. The adhesive composition of claim 1, wherein the polyalkylsilsesquioxane is polymethylsilsesquioxane, polyethylsilsesquioxane, polypropylsilsesquioxane, polybutylsilsesquioxane, polypentylsilsesquioxane, polyhexylsilsesquioxane, or polycyclohexylsilsesquioxane.

3. The adhesive composition of claim 1, wherein the polyalkylsilsesquioxane is polymethylsilsesquioxane, polyethylsilsesquioxane, or polypropylsilsesquioxane.

4. The adhesive composition of claim 1, wherein the polyalkylsilsesquioxane is polymethylsilsesquioxane.

5. The adhesive composition of claim 1, wherein the polyalkylsilsesquioxane has a particle size in the range of about 1.0 μm up to about 10 μm, and a surface area in the range of about 10 to about 50 m²/g.

6. The adhesive composition of claim 1, wherein the polyalkylsilsesquioxane has a particle size in the range of about 1.0 μm up to about 6 μm, and a surface area in the range of about 20 to about 30 m²/g.

7. The adhesive composition of claim 1 further comprising a coupling agent, an anti-oxidant, a stabilizer, a bleed control agent, additional fillers other than a polyalkylsilsesquioxane, an inert diluent, a reactive diluent, an adhesion promoter, a flexibilizer, a dye, a pigment, or a mixture of any two or more thereof.

8. The composition of claim 1, wherein the maleimide has the structure 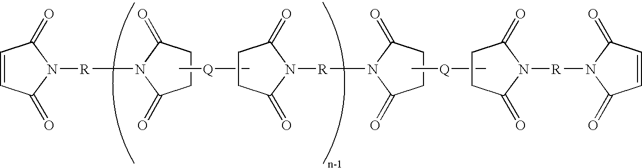
wherein:
R and Q are each independently substituted or unsubstituted aliphatic, aromatic, heteroaromatic, or siloxane moieties; and
n is 1 to about 10.

9. The adhesive composition of claim 8, wherein R and Q are each independently substituted or unsubstituted linear, branched, or cyclic aliphatic moieties having from 2 to about 100 carbon atoms.

10. The adhesive composition of claim 8, wherein R and Q are each independently substituted or unsubstituted aromatic or heteroaromatic moieties having from 6 to about 14 carbon atoms.

11. The adhesive composition of claim 8, wherein n is 1-6.

12. The adhesive composition of claim 8, wherein n is 1-4.

13. The adhesive composition of claim 8, wherein n is 2.

14. The adhesive composition of claim 1, wherein the urethane has the structure 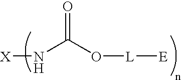
wherein:
X is a substituted or unsubstituted aliphatic, aryl or heterocyclic;
each E is independently a polymerizable moiety selected from acrylate, methacrylate, olefin, epoxy, maleimide, vinyl ether, or vinyl ester;
each L is independently a bond or an alkylene or oxyalkylene linker; and
n is 1 to about 10.

15. The adhesive composition of claim 14, wherein X is a substituted or unsubstituted linear, branched, or cyclic aliphatic moiety having from 2 to about 100 carbon atoms.

16. The adhesive composition of claim 14, wherein X is a substituted or unsubstituted aryl or heterocyclic moiety having from 6 to about 14 carbon atoms.

17. The adhesive composition of claim 14, wherein X is a substituted or unsubstituted linear, branched, or cyclic aliphatic moiety having from 2 to about 50 carbon atoms.

18. The adhesive composition of claim 14, wherein n is 1 to about 5.

19. The adhesive composition of claim 14, wherein n is 1 to about 3.

20. The adhesive composition of claim 14, wherein n is 2.

21. The adhesive composition of claim 1 wherein the polyester-linked (meth)acrylates have the structure 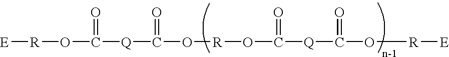
wherein:
R and Q are each independently substituted or unsubstituted aliphatic, aryl, or heteroaryl;
each E is independently an acrylate or a methacrylate; and
n is 1 to about 10.

22. The adhesive composition of claim 21, wherein R is a substituted or unsubstituted cycloalkyl having from 5 to about 20 carbon atoms.

23. The adhesive composition of claim 21, wherein R is a substituted or unsubstituted cycloalkyl having from 5 to about 12 carbon atoms.

24. The compound of claim 21, wherein R is a substituted or unsubstituted cyclopentyl, cyclohexyl, norbornyl, tetracyclododecyl, or dicyclopentadienyl.

25. The adhesive composition of claim 21, wherein Q is a substituted or unsubstituted aryl or heteroaryl having from 6 to about 14 carbon atoms.

26. The adhesive composition of claim 21, wherein Q is a substituted or unsubstituted phenyl or naphthyl.

27. The adhesive composition of claim 21, wherein Q is a substituted or unsubstituted cycloalkyl.

28. The adhesive composition of claim 21, wherein Q is a substituted or unsubstituted norbornenyl.

29. The adhesive composition of claim 1 wherein the composition is a thixotropic paste.

30. The adhesive composition of claim 1 wherein the composition is substantially free of solvent.

31. The adhesive composition of claim 1 wherein the monomer vehicle comprises about 25 to 90 weight percent (wt %) of the composition, the polyalkylsilsesquioxane comprises about 10 to 75 wt % of the composition, and the curing catalyst comprises about 0.01 to 10 wt % of the composition.

32. An assembly comprising a first article permanently adhered to a second article by a cured aliquot of a composition comprising a polymerizable monomer vehicle, a polyalkylsilsesquioxane, and a curing catalyst.

33. An assembly comprising a microelectronic device permanently adhered to a substrate by a cured aliquot of a composition comprising a polymerizable monomer vehicle, a polyalkylsilsesquioxane, and a curing catalyst.

34. A method for adhesively attaching a first article to a second article, comprising:
(a) applying an adhesive composition to the first article, wherein the adhesive composition comprises a polymerizable monomer vehicle, a polyalkylsilsesquioxane, and a curing catalyst,
(b) bringing the first and second article into intimate contact to form an assembly wherein the first article and the second article are separated only by the adhesive composition applied in step (a), and thereafter,
(c) subjecting the assembly to conditions suitable to cure the adhesive composition.

35. A method for adhesively attaching a microelectronic device to a substrate, the method comprising:
(a) applying an adhesive composition to the substrate and/or the microelectronic device, wherein the adhesive composition comprises a polymerizable monomer vehicle, a polyalkylsilsesquioxane, and a curing catalyst,
(b) bringing the substrate and the device into intimate contact to form an assembly wherein the substrate and the device are separated only by the composition applied in step (a), and thereafter,
(c) subjecting the assembly to conditions suitable to cure the composition.
